(19) United States
(12) Patent Application Publication
(10) Pub. No.: US 2015/0084553 A1
(43) Pub. Date: Mar. 26, 2015

(54) SYNCHRONOUS TRANSFER CONTROL SYSTEM IN AN ARC RESISTANT ENCLOSURE

(71) Applicant: EATON CORPORATION, CLEVELAND, OH (US)

(72) Inventors: THOMAS A. FARR, CANDLER, NC (US); BROOK B. BALDWIN, WEAVERVILLE, NC (US); JAMES R. ENLOE, FLETCHER, NC (US)

(73) Assignee: EATON CORPORATION, CLEVELAND, OH (US)

(21) Appl. No.: 14/032,895

(22) Filed: Sep. 20, 2013

(51) Int. Cl. H02P 1/54; H01H 33/08

(52) U.S. Cl. CPC H02P 1/54; H01H 33/08
USPC 318/101; 218/149

(57) ABSTRACT

A synchronous transfer control system includes an arc resistant enclosure having a main housing having an open top portion and an arc plenum, the arc plenum having a closed front portion, a closed rear portion, and at least one open side portion, and a plurality of synchronous transfer control components housed within the main housing including: (i) a hard bussed first bus structured to be coupled to a first power source, (ii) a second power source, and (iii) a hard bussed second bus, wherein an output of the second power source is able to be selectively coupled to the second bus, wherein the first bus is able to be selectively and individually coupled to each of the motors, and wherein the second bus is able to be selectively and individually coupled to each of the motors.

### BACKGROUND

1. Field

The disclosed concept relates generally to a system for controlling the operation of multiple electric motors in an industrial setting (e.g., a pumping station), and, in particular, to a synchronous transfer control system that is provided in an arc resistant enclosure that meets IEEE C37.20,7 standards,

2. Background Information

There are numerous settings wherein multiple motors are employed to drive heavy machinery. For example, multiple high horsepower electric motors are used in a pumping system, such as, without limitation, a water pumping system. As is known in the art, in such settings, there are a number of devices that can be used to control the motors. In particular, contactors, soft starters, and variable frequency drives (VFDs) (also referred to as adjustable frequency drives or AFDs) are different types of devices that can be used to control a motor in such a setting.

A contactor simply connects the motor directly across the AC line. A motor connected to the AC line will accelerate very quickly to full speed and draw a large amount of current during acceleration. Thus, use of a contactor only to control a motor has many drawbacks, and in many industrial settings will not be permitted by the electric utility. A soft starter is a device used to slowly ramp up a motor to full speed, and/or slowly ramp down the motor to a stop. Reducing both current draw and the mechanical strain on the system are big advantages of using a soft starter in place of a contactor. Many large pumps and fans require at least a 30-second ramp time to prevent mechanical damage to the system. Soft starters are more common on larger horsepower systems. A VFD not only has the ramping ability of a soft starter, but also allows the speed to be varied, while offering more flexibility and features.

In addition, in settings where multiple motors are employed, there is the danger that one or more of the motors and/or motor drive devices could experience a fault resulting in a dangerous explosion.

There is thus a need for a system for controlling the operation of multiple electric motors in an industrial setting that wilt also protect workers in the environment in the event of dangerous fault condition.

### SUMMARY

These needs and others are met by embodiments of the disclosed concept, which are directed to an arc resistant synchronous transfer control system for controlling operation of a number of electric motors. In one embodiment, the arc resistant synchronous transfer control system includes an arc resistant enclosure having a main housing having an open top portion and an arc plenum fluidly coupled to the top portion, the arc plenum having a closed front portion, a closed rear portion, and at least one open side portion structured for direct or indirect connection to a duct or vent system, the main housing having a number of enclosure members each made of a material having arc resistant ratings of 50 kA 0.5 s, Type 2B. The arc resistant synchronous transfer control system also includes a plurality of synchronous transfer control components housed within the main housing, the synchronous transfer control components including: (i) a hard bussed first bus structured to be coupled to a first power source, (ii) a second power source, and (iii) a hard bussed second bus, wherein an output of the second power source is able to be selectively coupled to the second bus, wherein the first bus is able to be selectively and individually coupled to each of the motors, and wherein the second bus is able to be selectively and individually coupled to each of the motors.

### BRIEF DESCRIPTION OF THE DRAWINGS

A full understanding of the disclosed concept can be gained from the following description of the preferred embodiments when read in conjunction with the accompanying drawings in which:

FIG. 1 is a schematic diagram of an arc resistant synchronous transfer control system 2 for controlling the operation of multiple electric motors according to an exemplary embodiment of the present invention;

FIG. 2 is a front view of arc resistant enclosure of the arc resistant synchronous transfer control system according to an exemplary embodiment of the present invention; and

FIGS. 3A, 3B and 3C are isometric, front and left side views, respectively, of an arc resistant sub-enclosure forming part of the arc resistant enclosure of FIG. 2.

### DESCRIPTION OF THE PREFERRED EMBODIMENTS

Directional phrases used herein, such as, for example, left, right, front, back, top, bottom and derivatives thereof, relate to the orientation of the elements shown in the drawings and are not limiting upon the claims unless expressly recited therein.

As employed herein, the term “fastener” refers to any suitable connecting or tightening mechanism expressly including, but not limited to, screws, bolts and the combinations of bolts and nuts (e.g., without limitation, lock nuts) and bolts, washers and nuts.

As employed herein, the statement that two or more parts are “coupled” together shall mean that the parts are joined together either directly or joined through one or more intermediate parts.

As employed herein, the term “number” shall mean one or an integer greater than one a plurality).

As employed herein, the terms “hard bus”, “hard bussed” or “hard bussing” shall refer to a system of one or more electrical conductors that makes a common connection between a number of circuits or circuit components and that employs metallic, e.g., copper, brass or aluminum, strips or bars that are connected, e.g., bolted, together, as opposed to a cable or cables that are strung together to interconnect a number of circuits or circuit components (which is usually used for field connections).

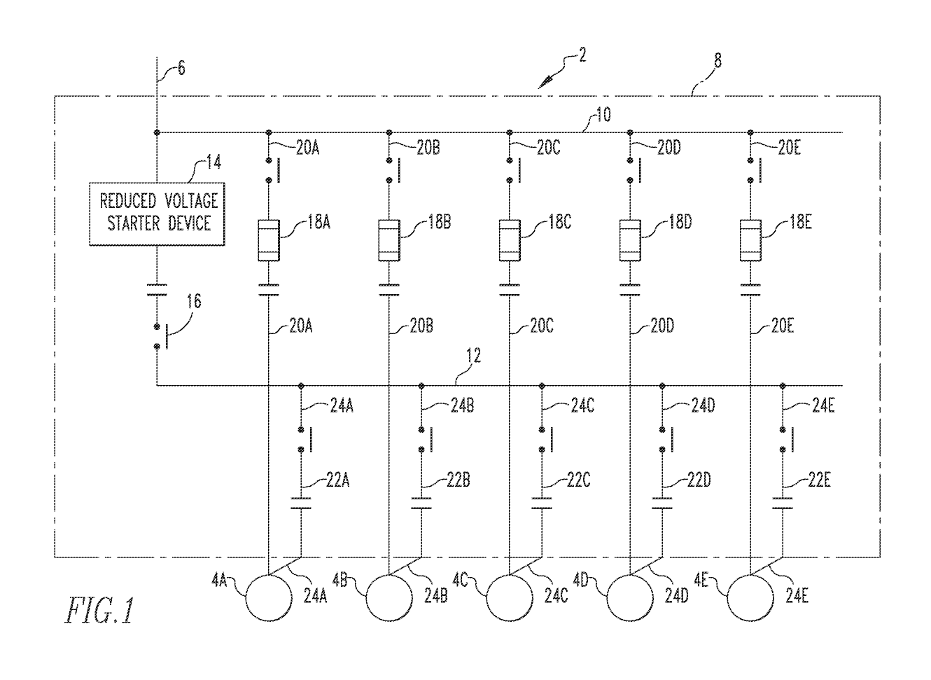

FIG. 1 is a schematic diagram of an arc resistant synchronous transfer control system 2 for controlling the operation of multiple electric motors according to an exemplary embodiment of the present invention. System 2 includes a plurality of electric motors 4. In the illustrated embodiment, five motors 4 (labeled 4A-4E) are provided. It will be understood, however, that more or less motors 4 may be provided within the scope of the present invention. System 2 further includes a main power source 6, which in the exemplary embodiment is a 4160 V, 60 Hz main power line (e.g., the 60 Hz utility supply).

As seen in FIG. 1, system 2 includes an arc resistant enclosure 8 that is structured to withstand an internal fault without endangering an operator who is standing in front of the equipment. In the exemplary embodiment, arc resistant enclosure 8 is structured to meet IEEE C37.20.7 standards, and thus be arc resistant at the front, sides and rear thereof, and to have the following arc resistant ratings: 50 kA - 0.5 s, Type 2B.

System 2 further includes a number of components that are provided in arc resistant enclosure 8. In particular, system 2 includes a main bus 110 that is directly coupled to main power source 6, and a secondary bus 12. In the exemplary embodiment, main bus 10 and secondary bus 12 are both hard bussed, and are made of, for example and without limitation, hard copper bus bars. As seen in FIG. 1, the input of a reduced voltage starter device 14 is coupled to main bus 10. In the exemplary embodiment, reduced voltage starter device 14 is a VFD. It will be understood, however, that reduced voltage starter device 14 may also take on other forms, such as a soft starter, or a VFD with a reduced voltage solid state (RVSS) bypass. As is known, this latter implementation employs both a VFD and an integral soft starter in a bypass configuration that allows the system to continue to run (via the soft starter) in the event that the VFD fails. In one particular exemplary embodiment, reduced voltage starter device 14 is an arc resistant VFD. The output of reduced voltage starter device 14 is coupled to an output isolation contactor 16, which in turn is coupled to secondary bus 12.

In addition, each motor 4A-4E is coupled to main bus 10 through an associated bypass contactor 18A-18E and bypass line 20A-20E. Each motor 4A-4E is also coupled to secondary bus 12 through an associated motor select contactor 22A-22E and motor select line 24A-24E. In the exemplary embodiment, bypass lines 20A-20E and motor select lines 24A-24E also hard bussed.

As noted above, in the exemplary embodiment, reduced voltage starter device 14 is a VFD in order to implement a synchronous transfer control system. In system 2, such a VFD accelerates the selected one of the motors 4A-4E to any frequency the user wants between 0 and 60 Hz. This speed control is one of the main advantageous features of a VFD. In system 2 implemented as a synchronous transfer control system, the VFD is told by the user (through a controller (e.g., PLC) coupled to the VFD) to synchronize with the applied line power on main line 10. The VFD then accelerates the selected one of the motors 4A-4E to 60 Hz, and then aligns the phase angle between the line power on main line 10 and the selected one of the motors 4A-4E to 60 Hz. When the selected one of the motors 4A-4E is in “sync” with applied line power on main line 10, the transfer occurs. Referring to FIG. 1, the sequence of operation of system 2 is thus as follows for a normal start. First, the user calls for a start of a selected one of the motors 4A-4E. In response, motor select contactor 22A-22E of the selected one of the motors 4A-4E is closed, and reduced voltage starter device 14 is started. The first action of reduced voltage starter device 14 is to close output isolation contactor 16. This will result in the selected one of the motors 4A-4E being connected to reduced voltage starter device 14 though the closed output isolation contactor 16 and closed motor select contactor 22A-22E. During this process, the bypass contactors 18A-18E remain open. Reduced voltage starter device 14 energizes and ramps the selected one of the motors 4A-4E. When the ramping is complete, reduced voltage starter device 14 aligns with main bus 10, and closes the bypass contactor 18A-18E of the selected one of the motors 4A-4E, and turns itself off. Finally, output isolation contactor 16 the motor select contactor 22A-22E of the selected one of the motors 4A-4E is opened. Reduced voltage starter device 14 is now available to start another one of the motors 4A-4E.

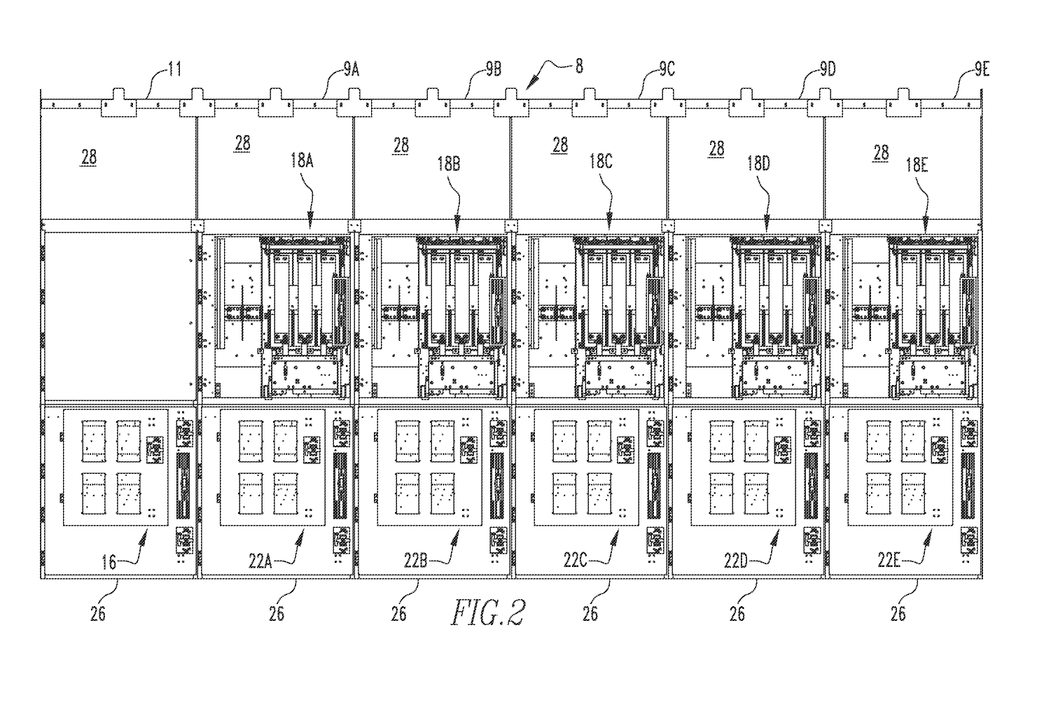

FIG. 2 is a front view of arc resistant enclosure 8 showing certain components that are provided in arc resistant enclosure 8. As seen in FIG. 2, arc resistant enclosure 8 is made up of a number of a number arc resistant sub-enclosures 9 (labeled 9A-9E in the exemplary embodiment), and an arc resistant sub-enclosures 11, which are described in detail below. The arc resistant sub-enclosures 9 and the arc resistant sub-enclosures 11 are positioned immediately next to one another to form arc resistant enclosure 8, with each one of the arc resistant sub-enclosures 9A-9E corresponding to one of the motors 4A-4E.

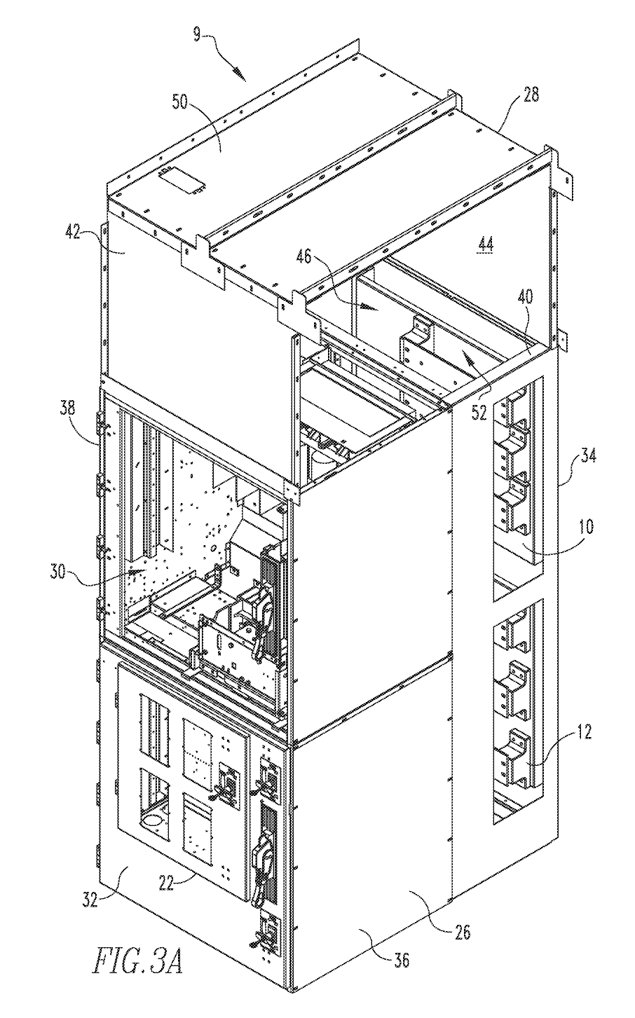

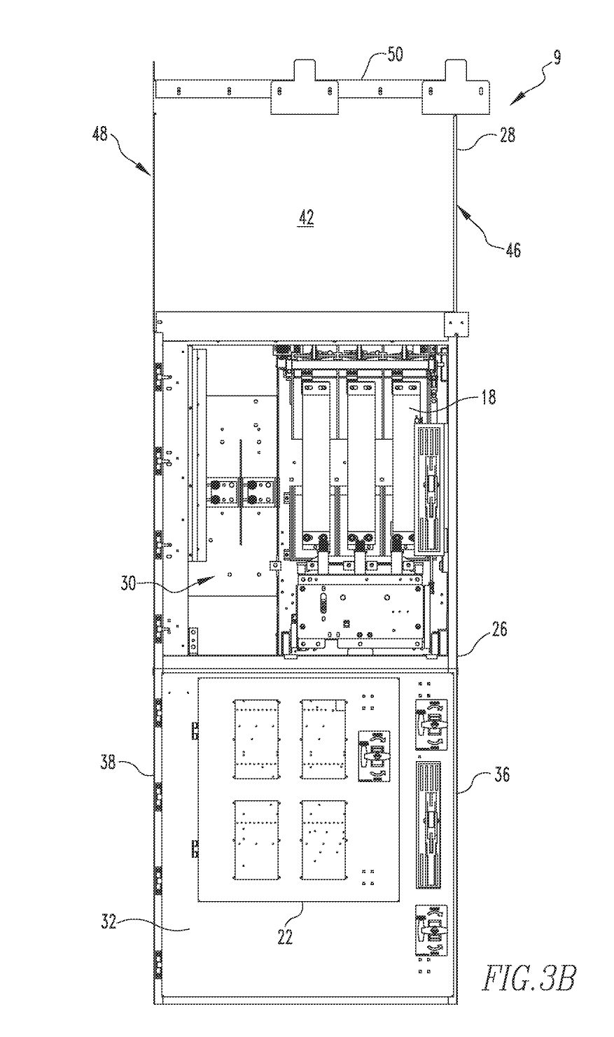

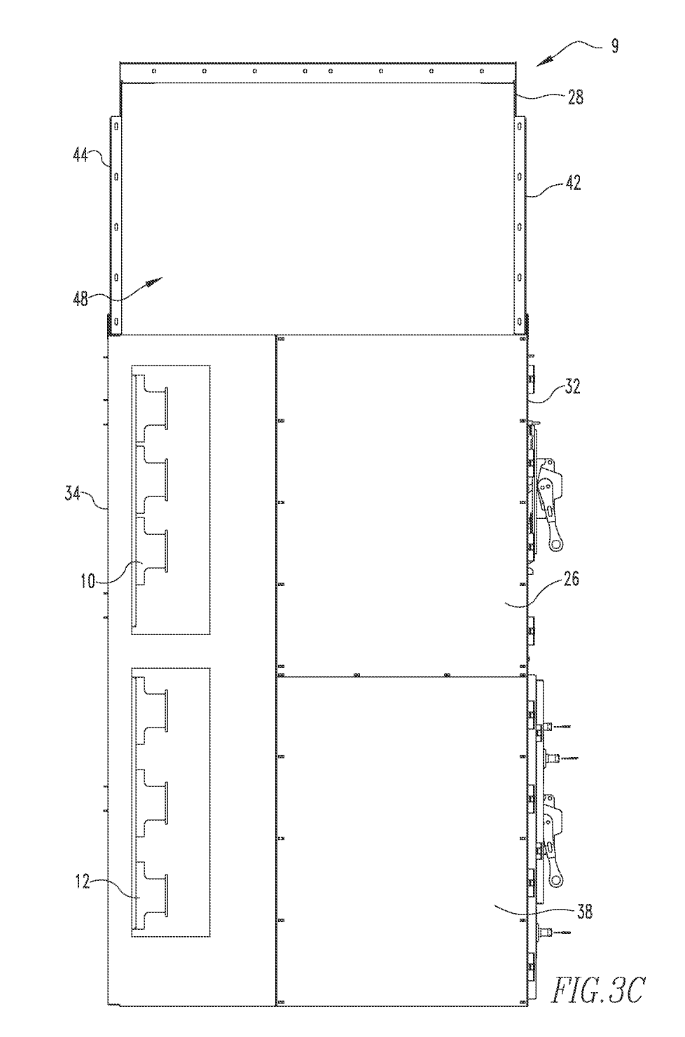

FIGS. 3A, 3B and 3C are isometric, front and left side views, respectively, of one of the arc resistant sub-enclosure 9 (i.e., one of 9A-9E) showing certain components that are provided therein. Each arc resistant sub-enclosure 9 includes a main housing 26 which houses a number of the components of system 2, and an arc plenum 28. Main housing 26 includes a front portion 32, a rear portion 34, a right side portion 36, a left side portion 38, and an open top portion 40. Arc plenum 28 is attached to top portion 40 of main housing 26. Front portion 32, rear portion 34, right side portion 36, and left side portion 38 each include one or more enclosure members (e.g., a wall or cover with corner bracing) made of a material having arc resistant ratings of 50 kA-0.5 s, Type 2B, such as, without limitation, 12 gauge mild (low carbon) steel. In FIGS. 3A and 3B, one such member is removed from front portion 32 in order to show the internal compartment 30 of main housing 26.

Arc plenum 28 has a front portion 42, a rear portion 44, an open right side portion 46, an open left side portion 48, a top portion 50, and an open bottom portion 52. Front portion 42, rear portion 44 and top portion 50 each include one or more enclosure members (e.g., a wall or cover with corner bracing) made of a material having arc resistant ratings of 50 kA-0.5s, Type 2B, such as, without limitation, 12 gauge mild (low carbon) steel. Arc plenum 28 (and therefore internal compartment 30 of main housing 26) is structured to be fluidly connected to a venting/duct system, similar to an HVAC duct, via open right side portion 46 and/or open left side portion 48. Arc resistant sub-enclosures 11 is similar in structure to arc resistant sub-enclosure 9 as just described. When arc resistant sub-enclosures 9A-9E and 11 are positioned adjacent one another as shown in FIG. 2, the arc plenums 28 are coupled to one another and then to venting/duct system.

As seen in FIG. 2 and FIGS. 3A, 3B and 3C, at least the following components of system 2 are housed within arc resistant enclosure 8 in a manner such that they are configured to operate as shown in FIG. 1: main bus 10, secondary bus 12, reduced voltage starter device 14, output isolation contactor 16, bypass contactors 18A-18E and motor select contactors 22A-22E. More specifically, a portion of main bus 10, a portion of secondary bus 12, reduced voltage starter device 14, and output isolation contactor 16 are housed within the internal compartment of main housing 26 of arc resistant sub-enclosure 11, and a portion of main bus 10, a portion of secondary bus 12, a respective one of the bypass contactors 18A-18E and a respective one of motor select contactors 22A-22E are housed within the internal compartment of main housing 26 of each arc resistant sub-enclosure 9.

Arc resistant enclosure 8 thus functions as an arc resistant enclosure that meets IEEE C37.20.7 standards for system 2, In operation, in the case of a failure of system 23, hot gasses and/or pressure waves will be vented up main housing 26 and through arc plenum(s) 28 to the associated venting/duct system (and thus away from personnel). In addition, such personnel will be protected/shielded from such hot gasses and/or pressure waves by the enclosure members of main housing 26 and arc plenum 28.

In one embodiment, multiple arc resistant enclosures 8 may be placed side by side to one another in a configuration wherein the arc plenums 28 thereof are in communication with one another (the left side portion 48 of one being adjacent the right side portion 46 of another, and so on) so as to provide an escape-way for hot gasses and/or pressure waves in the event of a failure of one or more of the arc resistant enclosures 8.

While specific embodiments of the disclosed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosed concept which is to be given the full breadth of the claims appended and any and all equivalents thereof.

What is claimed is:

1. A synchronous transfer control system for controlling operation of a number of electric motors, comprising:
an arc resistant enclosure having a main housing having an open top portion and an arc plenum fluidly coupled to the top portion, the arc plenum having a closed front portion, a closed rear portion, and at least one open side portion structured for direct or indirect connection to a duct or vent system, the main housing having a number of enclosure members each made of a material having arc resistant ratings of 50 kA -0.5 s, Type 2B;
a plurality of synchronous transfer control components housed within the main housing, the synchronous transfer control components including: (i) a hard bussed first bus structured to be coupled to a first power source, (ii) a second power source, and (iii) a hard bussed second bus, wherein an output of the second power source is able to be selectively coupled to the second bus, wherein the first bus is able to be selectively and individually coupled to each of the motors, and wherein the second bus is able to be selectively and individually coupled to each of the motors.

2. The synchronous transfer control system according to claim 1, wherein the second power source is a reduced voltage starter device, wherein an input of the reduced voltage starter device is coupled to the first bus.

3. The synchronous transfer control system according to claim 2, wherein the reduced voltage starter device comprises a variable frequency drive.

4. The synchronous transfer control system according to claim 3, wherein the variable frequency drive is an arc resistant variable frequency drive.

5. The synchronous transfer control system according to claim 2, wherein the plurality of synchronous transfer control components include a first switching device, a number of second switching devices, and a number of third switching devices, wherein an output of the reduced voltage starter device is coupled to the second bus through the first switching device, wherein the first bus is structured to be selectively coupled to each of the motors through a respective one of the second switching devices, and wherein the second bus is structured to be selectively coupled to each of the motors through a respective one of the third switching devices

6. The synchronous transfer control system according to claim 5, wherein the first switching device, each of the second switching devices and each of the third switching devices is a contactor.

7. The synchronous transfer control system according to claim 1, wherein the first bus and the second bus is each a hard bussed copper bus.

8. The synchronous transfer control system according to claim 1, wherein the arc plenum includes an open right side portion and an open left side portion.

9. The synchronous transfer control system according to claim 1, wherein the enclosure members are each made of a metal having arc resistant ratings of 50 kA-0.5 s, Type 2B.

10. The synchronous transfer control system according to claim 1, wherein the enclosure members are each made of 12 gauge mild steel.
